(19) United States
(12) Patent Application Publication
(10) Pub. No.: US 2021/0184876 A1
(43) Pub. Date: Jun. 17, 2021

(54) AUTOMATIC CONFERENCE MANAGEMENT TOOL

(71) Applicant: T-Mobile USA, Inc., Bellevue, WA (US)

(72) Inventors: Michele Kinsey, Seattle, WA (US); Adrian Synal, Kirkland, WA (US); Shelby Seward, North Bend, WA (US); Zoltan Homorodi, North Bend, WA (US); Jonathan Pastore, Bellevue, WA (US)

(21) Appl. No.: 16/712,880

(22) Filed: Dec. 12, 2019

(51) Int. Cl. H04L 12/18; H04L 12/58

(52) U.S. Cl. CPC H04L 12/1818; H04L 12/1822; H04L 51/02

(57) ABSTRACT

Techniques are described herein for implementing a conference management tool to start, schedule, and manage conferences. The techniques include receiving a scheduling request to schedule a conference from a user device via a communication channel. The communication channel can include a chatbot that is configured to access a calendar and an address book to fulfill the scheduling request. The chatbot may add a calendar association comprising the conference information to the calendar and retrieve contact information associated with one or more participants of the conference from the address book. The chatbot may also send a conference notification to the one or more participants, wherein the conference notification includes conference information that is associated with a conference code that may be presented to the user device.

### BACKGROUND

To organize a teleconference or a video conference, an organizer of the conference provides information such as the conference date, time, location, and the subject of the conference. The organizer may also identify participants to attend the conference and the conference information is sent to the participants (e.g., via an electronic mail). Additionally, or alternatively, an organizer of the conference may log onto a conferencing platform via a user device at the desired time to communicate with other participants without scheduling a conference ahead of time. To maximize participation, the organizer of the conference must correspond with multiple participants, which can be a tedious process that requires much time and coordination. This process can become more complex as additional participants are invited to the conference. By streamlining the process for scheduling a conference and enabling participants to join the conference, a better user experience may be provided to the organizer and the participants.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates example network architecture for implementing a conference management tool to start, schedule, and manage conferences using one or more communication channels.

FIG. 2 is a block diagram showing various components of an illustrative user device that implements a conference management application.

FIG. 3 is a block diagram showing various components of an illustrative conference management device that is configured to provide a conference code that can be associated with conference information.

FIG. 4 is a block diagram showing various components of an illustrative server for scheduling and managing conferences.

FIG. 5 illustrates example architecture for implementing a chatbot to schedule and manage conferences.

FIG. 6 is a flow diagram of an example process for scheduling a conference.

FIG. 7 is a flow diagram of an example process for updating conference information and initiating a conference.

### DETAILED DESCRIPTION

This disclosure is directed to techniques for organizing teleconferences and video conferences. In some aspects, the techniques may implement a teleconferencing and/or videoconferencing system that includes a conference management server. The conference management server is configured to communicate with a user device to receive scheduling requests and to provide notifications to participants of a scheduled conference. The user device may include a locally installed conference management application that may facilitate sending a scheduling request to the conference management server via a communication channel, wherein the communication channel can include text message, email, phone, or chatbot. The scheduling request may include the desired date, time, location, a conference subject, and an identification of at least one participant.

In another embodiment, a user device may interact with a kiosk to schedule a conference via a locally installed conference management application. The kiosk may communicate the scheduling request to a conference management server, which in turn may make calendar associations on a calendar that is associated with a user account of a user operating the user device. In one example, the user may set up a user account using the conference management application. The conference management server may provide conference notifications to at least one participant in the conference.

In some aspects, the conference management server may provide conference notifications to the kiosk. Upon receiving the conference notifications, the kiosk may generate a unique conference code that is associated with conference information. The conference code may be various types of computer-readable code that may be entered or scanned via a user device. To initiate or attend the conference, a participant may enter or scan the generated code in the conference management application. In response, the user device may establish communication with additional user devices via a communication channel in a conference. For example, the conference code may be linked to a virtual chatroom in which users can engage in a chat session via text or short message service (SMS).

In various embodiments, a kiosk may provide a user interface such as a touchpad or a touch screen display and/or a web-based user interface for receiving user input (e.g., a scheduling request) and provide information such as a unique conference code that may be associated with conference information. A participant of a conference may enter the code in a conference management application using a user device to organize a conference, manage a conference, and/or to retrieve information about a conference. In one example, entering or scanning the conference code may initiate a short message system (SMS) conversation or a chat session with a chatbot to provide virtual assistance to the participant. The chatbot may assist the participant with scheduling a conference, inviting participants, modifying the conference, notifying participants, and/or so forth. In another example, the conference code may be linked to an event website from which the user may obtain details about the conference.

In various embodiments, the kiosk may be configured to detect the presence (e.g., via Bluetooth) of a user device that is located within a predetermined distance of the kiosk. In response to determining that the user device is located within the predetermined distance, the kiosk may verify that the user device is associated with contact information of a participant of a conference. Upon verification, the kiosk may send the conference code to the user device and the user device may provide a push notification to prompt the user to initiate or join the conference that is associated with the conference code.

The techniques described herein may be implemented in a number of ways. Example implementations are provided below with reference to the following figures.

### Example Network Architecture

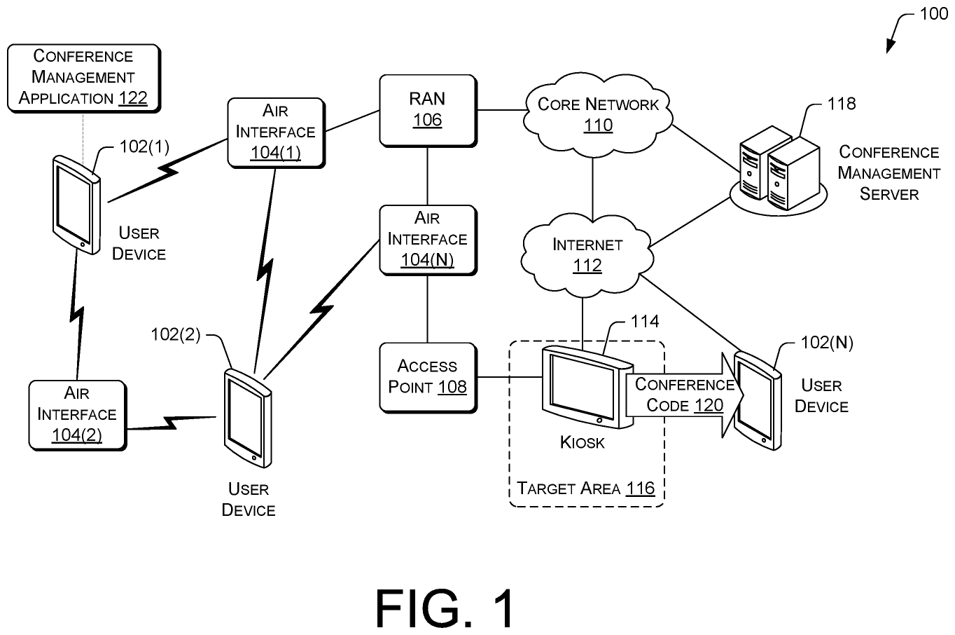

FIG. 1 illustrates an example architecture of a wireless communication network 100 in accordance with various aspects of this disclosure. The wireless communication network 100 may include one or more user devices 102(1)-102(N). The user devices 102(1)-102(N) may include smartphones, mobile devices, personal digital assistants (PDAs), gaming consoles, voice-activated virtual assistants, television receivers, and/or other electronic devices having a wireless communication function that are capable of receiving input, processing the input, and generating output data.

The user devices 102(1)-102(N) are configured to communicate with an access network (e.g., the RAN 106, an access point 108, etc.) over a physical communications interface or layer, shown in FIG. 1 as air interfaces 104(1)-104(N) and/or a direct-wired connection. In some aspects, the air interface 104(1) can comply with a given cellular communications protocol (e.g., 2G, 3G, 4G, and long-term evolution [LTE], LTE advanced, high-speed data packet access [HSDPA], evolved high-speed packet access [HSPA+], universal mobile telecommunication system [UMTS], code-division multiple access [CDMA], global system for mobile communications [GSM], etc.), while the air interface 104(2) can comply with a wireless IP protocol (e.g., Wi-Fi, IEEE 802.11). The RAN 106 includes a plurality of access points that serve user devices 102(1)-102(N) over air interfaces 104(1)-104(N). The access points in the RAN 106 can be referred to as access nodes or ANs, access points or APs, base stations or BSs, Node Bs, eNode Bs, and so on. These access points can be terrestrial access points (or ground stations), or satellite access points. The RAN 106 is configured to connect to a core network 110 that can perform a variety of functions, including bridging circuit-switched (CS) calls between user devices 102(1)-102(N) served by the RAN 106 and other user devices 102(1)-102(N) served by the RAN 106 or a different RAN altogether, and can also mediate an exchange of packet-switched (PS) data with external networks such as Internet 112. The Internet 112 includes a number of routing agents and processing agents (not pictured). In FIG. 1, the user device 102(N) is shown as connecting to the Internet 112 directly (i.e., separate from the core network 110, such as over an Ethernet connection of a Wi-Fi or an IEEE 802.11-based network). The Internet 112 can thereby function to bridge packet-switched data communications between the user device 102(N) and user devices 102(1) and 102(2) via the core network 110.

The access point 108 may be separate from the RAN 106. The access point 108 may be connected to the Internet 112 independent of the core network 110 (e.g., via an optical communication system such as FiOS, a cable modem, etc.). The air interface 104(2) may serve the user device 102(1) over a local wireless connection, such as IEEE 802.11. Any of the user devices 102(1)-102(N) may be a desktop computer with a direct wired connection to the Internet 112, such as a direct connection to a modem or router, which can correspond to the access point 108 in an example (e.g., for a Wi-Fi router with both wired and wireless connectivity).

The core network 110 is configured to support one or more communication services (e.g., Voice-over-Internet Protocol (VoIP)) sessions, Push-to-Talk (PTT) sessions, group communication sessions, social networking services, etc.) for user devices 102(1)-102(N) that can connect to the core network 110 via the RAN 106 and/or via the Internet 112, and/or to provide content (e.g., web page downloads) to the user devices 102(1)-102(N).

One or more of the various user devices 102(1)-102(N) in FIG. 1 may include a locally installed conference management application 122. In other aspects, the conference management application 122 is network or web-based. The conference management application 122 may support various teleconferencing and/or video conferencing functionalities. For example, the conference management application 122 may enable users to schedule a conference, request a conference, invite participants, initiate a conference, join a conference, leave a conference, terminate a conference, and/or so forth. The conference management application 122 may also provide group chat functions, calendar synchronization, address book synchronization, collaboration functions, presentation mode, screen share, virtual whiteboard, notes, and/or so forth.

Additionally, or alternatively, the conference management application may be installed in an interactive kiosk 114. The kiosk 114 can comprise general-purpose computers such as desktop computers, tablet computers, laptop computers, servers (e.g., on-premise servers), workstations, network appliances, Internet appliances, personal digital assistant (PDA), smartphone, television system, or other electronic devices that are capable of receiving input, processing the input, and generating output data. The kiosk 114 may also be teleconferencing and/or videoconferencing systems for facilitating audio and/or video communications. In various embodiments, the conference management application may be a component of a teleconferencing and/or videoconferencing system.

In some aspects, the kiosk 114 may be physically located in a target area 116 such as a conference room. Thus, the kiosk 114 may be dedicated to managing conference services for a single conference room. In various embodiments, the kiosk 114 may be associated with multiple conference rooms. In one example, the kiosk 114 may be located in a central location or a common location near one or more conference rooms. The kiosk 114 may also be in a remote location.

As will be described in further detail below, the kiosk 114 may include a code generator that generates unique conference code that is associated with conference information such as date, time, location, and participants of a conference. The conference code 120 can be a computer-readable code such as a QR code, Aztec code, Maxicode, Data Matrix, and/or various types of barcode such as visual code, spot code, and magneti-code. Additionally, the conference code 120 may comprise a combination of letters, numbers, characters, and/or symbols. The conference code 120 may be presented or displayed on a user interface of the kiosk 114, which in turn may be scanned or read via an image capturing device (e.g., a camera) and/or a scanner of a user device to perform one or more operations. The one or more operations include retrieving information relating to a conference, initiating a conference, joining a conference, updating conference information, inviting additional participants, and/or so forth. For example, the kiosk 114 may provide a touch user interface using a touchpad or touch screen display and/or a web-based user interface. In various embodiments, the kiosk 114 may also include a communications device for transmitting the conference code 120 to a user device over one or more of the air interfaces 104(1)-104(N).

The network 100 further includes a conference management server 118. The conference management server 118 is connected to the Internet 112, the core network 110, or both. The conference management server 118 may include general-purpose computers, such as desktop computers, tablet computers, laptop computers, servers (e.g., on-premise servers), or other electronic devices that are capable of receiving input, processing the input, and generating output data. The conference management server 118 may store data in a distributed storage system, in which data may be stored for long periods of time and replicated to guarantee reliability.

The conference management server 118 may provide data and processing redundancy, in which data processing and data storage may be scaled in response to demand. Further, in a networked deployment, new conference management servers may be added. Thus, the conference management server 118 can include a plurality of physical machines that may be grouped together and presented as a single computing system. Each physical machine of the plurality of physical machines may comprise a node in a cluster. The conference management server 118 may also be in the form of virtual machines, such as virtual engines (VE) and virtual private servers (VPS).

In various embodiments, the conference management server 118 may access cloud infra services that may be accessible via an integrated cloud infrastructure. The cloud infrastructure may provide access to cloud infra services such as providing computing resources to support data portioning, scaling, security, and backup. The cloud infrastructure may also support billing services and other monetization services (e.g., conference management related services, teleconferencing and/or videoconferencing systems, etc.). The cloud infrastructure may provide additional service abstractions such as Platform as a Service (PaaS), Infrastructure as a Service (IaaS), and/or Software as a Service (SaaS), depending upon embodiments.

As will be described below, the conference management server 118 may schedule conferences and provide notifications related to the conference. In some aspects, the conference management server 118 may include one or more components such as a scheduling module and a notification module. The scheduling module may schedule a new conference and/or update a scheduled conference in response to receiving requests from one or more user devices 102(1)-102(N) or the kiosk 114. In one example, a user device may communicate a scheduling request to the conference management server 118. The scheduling module may schedule a conference based at least on the request, which may include date, time, location, subject of the conference, and participants. Additionally, the scheduling module may make calendar associations on a calendar, wherein the calendar association may include conference information based at least on the request and date/time.

The notification module of the conference management server 118 may provide conference scheduling notifications to one or more participants and receive replies from the participants. If the scheduling module determines that there is a scheduling conflict, the scheduling module may return a suggested alternate date, time, and/or location and the notification module may communicate the recommendations to the user device. Upon scheduling a conference, the conference management server 118 may provide conference notifications including conference information to the kiosk 114, which in turn may generate a conference code that is associated with the conference information.

The conference management server 118 may also facilitate establishing communication among user devices 102(1)-102(N) via a communication channel. The communication channel may include a chatbot that is supported via a chatbot application. In one example, an organizer of a conference may enter or scan a conference code to engage in a short message service (SMS) conversation or a chat session with the chatbot when scheduling the conference. The chatbot may prompt the organizer to provide information relating to the conference such as an alternate date, time, and location of the conference. The chatbot may also prompt the organizer to provide contact information associated with the participants of the conference. In response, the organizer may share a participant's contact information from the organizer's address book. The chatbot may also be configured to access one or more databases to retrieve information (e.g., contact information, scheduling information, calendar information, location information, etc.) to fulfill requests from a user device. In one example, the chatbot may be configured to access user account databases (e.g., home location register [HLR], home subscriber server [HSS], etc.), enterprise databases, and/or various data sources such as user devices. Additionally, the organizer may request a change to the conference date, time, location, and/or list of participants during the chat session.

The chatbot may also engage in a chat session with other participants of a conference. In one example, the chatbot may assist a participant in joining a conference by providing instructions or information relating to the conference. The chatbot may also assist a participant in sending a message to an organizer or other participants of a conference. The message may indicate that the participant will be late to join the conference. The message may also indicate that the participant is experiencing technical difficulties.

### Example Computing Device Components

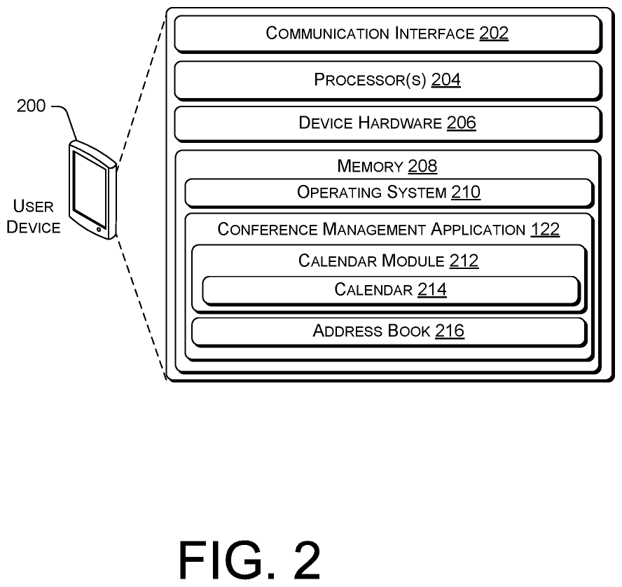

FIG. 2 is a block diagram showing various components of an illustrative computing device, wherein the computing device can comprise a user device 200. The user device 200 corresponds to one or more user devices 102(1)-102(N) of FIG. 1. It is noted that the user device 200 as described herein can operate with more or fewer of the components shown herein. Additionally, the user device 200 as shown herein or portions thereof can serve as a representation of one or more of the computing devices of the present system.

The user device 200 may include a communication interface 202, one or more processors 204, hardware 206, and memory 208. The communication interface 202 may include wireless and/or wired communication components that enable the user device 200 to transmit data to and receive data from other networked devices. In at least one example, the one or more processor(s) 204 may be a central processing unit(s) (CPU), graphics processing unit(s) (GPU), both a CPU and GPU or any other sort of processing unit(s). Each of the one or more processor(s) 204 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution.

The one or more processor(s) 204 may also be responsible for executing all computer applications stored in the memory, which can be associated with common types of volatile (RAM) and/or nonvolatile (ROM) memory. The hardware 206 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 208 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 208 may also include a firewall. In some embodiments, the firewall may be implemented as hardware 206 in the user device 200.

The processors 204 and the memory 208 of the user device 200 may implement an operating system 210 and a conference management application 212. The operating system 210 may include components that enable the user device 200 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The conference management application 212 includes a calendar module 214 and an address book 216. The calendar module 214 may be configured to perform various calendar activities such as entering, storing, retrieving, modifying, and deleting a conference, a meeting, an appointment, and/or other calendar association on a calendar 214. A calendar association may include information that is associated with a specified calendar date and/or time. In various embodiments, the calendar module 214 may communicate with a conference management server to make calendar associations. The calendar 214 may be associated with one or more user accounts associated with a user. For example, the calendar 214 may be associated with a personal email account of a user. In another example, the calendar 214 may be associated with a work email account of a user. In yet another example, the calendar 214 (e.g., an organizational calendar) may be associated with user accounts associated with multiple users.

The calendar module 214 may be configured to synchronize one or more calendars associated with a user to provide all calendar associations on a single calendar in a consolidated manner. In this way, one calendar may show calendar associations from multiple calendars associated with a user, wherein the calendars may be associated with the user's personal email account, work email account, and/or other user accounts. In some aspects, the calendar module 214 may mute or hide one or more calendar associations based at least on user settings. Additionally, or alternatively, the calendar module 214 may mute or hide one or more calendars based at least on user settings.

The address book 216 may be configured to add, store, modify, and delete contact information. The contact information may include a contact's name, phone number, email address, mailing address, and/or so forth. The address book 216 may import contact information from one or more address books associated with a user. For example, the address book 216 may import contact information from an address book that is locally stored in the user device 200. In another example, the address book 216 may import contact information from an address book that is stored in a remote database or a cloud. Contact information for one or more participants of a conference may be retrieved from the address book 216 in order to provide conference notifications to the one or more participants. In some aspects, the conference management application 212 may include a data management layer that includes software utilities for facilitating the acquisition, processing, storing, reporting, and analysis of calendar associations and/or contact information from multiple data sources such as calendars, address books, and/or so forth.

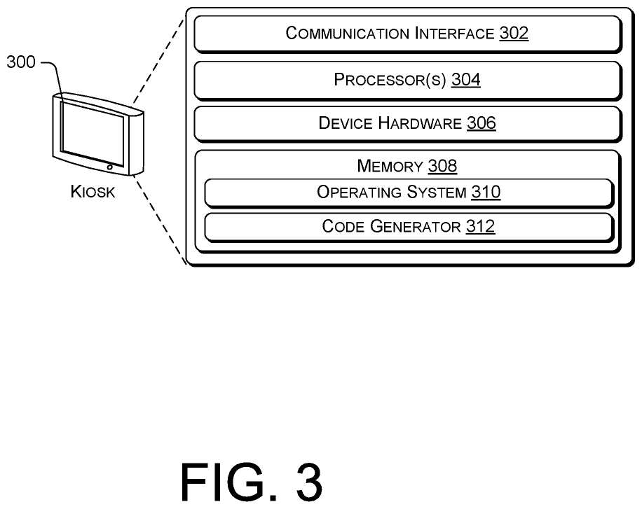

FIG. 3 is a block diagram showing various components of an illustrative computing device, wherein the computing device can comprise a conference kiosk 300. The conference kiosk 300 corresponds to the kiosk 114 of FIG. 1. It is noted that the conference kiosk 300 as described herein can operate with more or fewer of the components shown herein. Additionally, the conference kiosk 300 as shown herein or portions thereof can serve as a representation of one or more of the computing devices of the present system.

The conference kiosk 300 may include a communication interface 302, one or more processors 304, hardware 306, and memory 308. The communication interface 302 may include wireless and/or wired communication components that enable the conference management server to transmit data to and receive data from other networked devices. In at least one example, the one or more processor(s) 304 may be a central processing unit(s) (CPU), graphics processing unit(s) (GPU), both a CPU and GPU or any other sort of processing unit(s). Each of the one or more processor(s) 304 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution.

The one or more processor(s) 304 may also be responsible for executing all computer applications stored in the memory, which can be associated with common types of volatile (RAM) and/or nonvolatile (ROM) memory. The hardware 306 may include additional user interfaces, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 308 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 308 may also include a firewall. In some embodiments, the firewall may be implemented as hardware 306 in the conference kiosk 300.

The processors 304 and the memory 308 of the conference kiosk 300 may implement an operating system 310 and a code generator 312. The operating system 310 may include components that enable the conference kiosk 300 to receive and transmit data via various interfaces (e.g., user controls, communication interface, and/or memory input/output devices), as well as process data using the processors 304 to generate output. The operating system 310 may include a presentation component that presents the output (e.g., display the data on an electronic display, store the data in memory, transmit the data to another electronic device, etc.). Additionally, the operating system 310 may include other components that perform various additional functions generally associated with an operating system.

The code generator 312 is configured to generate a unique conference code associated with conference information. For example, the conference code may be associated with the date, time, location of a conference, one or more participants of the conference, one or more organizers of the conference, a subject matter of the conference, and/or so forth. Upon receiving communication from a conference management server indicating that a conference has been scheduled or a calendar association for the conference has been made on a calendar, the code generator 312 generates a conference code that can identify conference details. In some aspects, the conference code may be linked to a website such as an event website. As described above, the conference code may be various types of computer-readable code (e.g., QR code, Aztec code, Maxicode, Data Matrix, and/or various types of barcode such as visual code, spot code, and magneti-code, etc.) that a participant may enter or scan in the conference management application using a user device.

A user device may enter or scan the conference code to perform one or more operations. The operations may include retrieving conference information or initiating or joining the conference. The participant may activate a camera on a user device and point it towards the conference code, which may comprise a QR code. The user device may utilize a dedicated QR code scanning application. Additionally, or alternatively, the user device may utilize a conference management application. In response to reading the conference code, the user device may present a push notification requiring the participant to tap it to finish the relevant operation (i.e., open a website on a browser to join a videoconference or call a conference number).

In another example, an organizer of the conference may enter or scan the conference code to reschedule or modify conference information. In response to reading the conference code, the user device may open the conference management application to receive user input comprising an update request. Upon updating the conference information based at least on the update request, the conference code may be associated with the updated conference information.

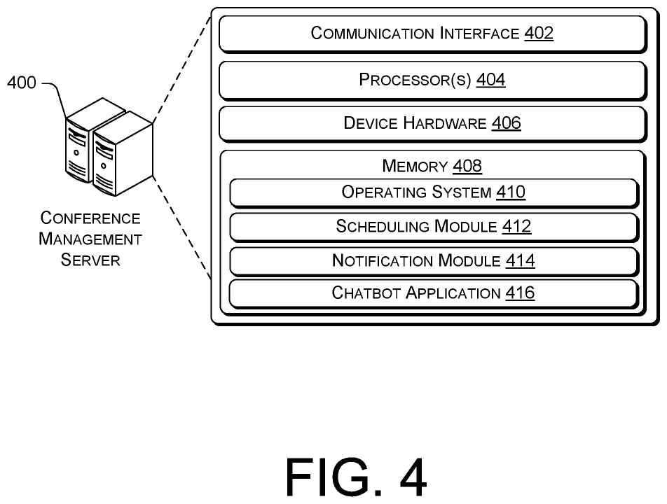

FIG. 4 is a block diagram showing various components of an illustrative computing device, wherein the computing device can comprise a conference management server 400. The conference management server 400 corresponds to the conference management server 118 of FIG. 1. It is noted that the conference management server as described herein can operate with more or fewer of the components shown herein. Additionally, the conference management server as shown herein or portions thereof can serve as a representation of one or more of the computing devices of the present system.

The conference management server 400 may include a communication interface 402, one or more processors 404, hardware 406, and memory 408. The communication interface 402 may include wireless and/or wired communication components that enable the conference management server to transmit data to and receive data from other networked devices. In at least one example, the one or more processor(s) 404 may be a central processing unit(s) (CPU), graphics processing unit(s) (GPU), both a CPU and GPU, or any other sort of processing unit(s). Each of the one or more processor(s) 404 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution.

The one or more processor(s) 404 may also be responsible for executing all computer applications stored in the memory, which can be associated with common types of volatile (RAM) and/or nonvolatile (ROM) memory. The hardware 406 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 408 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 408 may also include a firewall. In some embodiments, the firewall may be implemented as hardware 406 in the conference management server 400.

The processors 404 and the memory 408 of the conference management server 400 may implement an operating system 410, a scheduling module 412, a notification module 414, and a chatbot application 416. The operating system 410 may include components that enable the conference management server 400 to receive and transmit data via various interfaces (e.g., user controls, communication interface, and/or memory input/output devices), as well as process data using the processors 404 to generate output. The operating system 410 may include a presentation component that presents the output (e.g., display the data on an electronic display, store the data in memory, transmit the data to another electronic device, etc.). Additionally, the operating system 410 may include other components that perform various additional functions generally associated with an operating system.

The scheduling module 412 may schedule a new conference and/or update a scheduled conference in response to receiving requests from one or more user devices or the kiosk. In one example, the scheduling module 412 may schedule a conference based at least on the request from a user device, which may include date, time, location, subject of the conference, and participants. Additionally, the scheduling module 412 may add a calendar association comprising conference information on a calendar. Additionally, or alternatively, the scheduling module 412 may communicate the conference information to the calendar module of the conference management application to add calendar associations to a user's calendar. Upon adding a calendar association, the scheduling module 412 may instruct the notification module 414 of the conference management server 400 to provide conference notifications to one or more participants. The notification module 414 may forward replies (e.g., RSVP) from the participants back to the scheduling module 412. If the scheduling module 412 determines that there is a scheduling conflict, the scheduling module 412 may recommend alternate date, time, and/or location. Upon scheduling a conference, the conference management server 400 may provide conference information to the kiosk, which in turn may generate a conference code that is associated with the conference information.

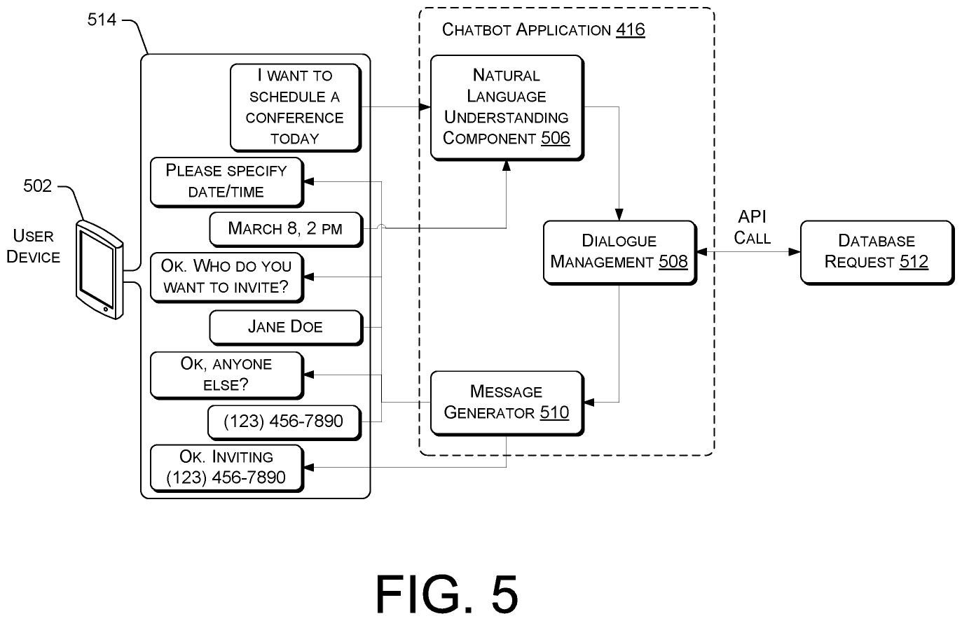

In some aspects, the conference management server 400 may provide a chatbot application 416 for interacting with the user devices to enhance the user experience, which is described with respect to FIG. 5 below.

FIG. 5 illustrates example architecture for implementing a chatbot to manage conferences. The user device 502 may be able to communicate with a conference management server via a communication channel, wherein the communication includes a chatbot that is supported by a chatbot application 416. The chatbot application 416 may enable the user device 502 to engage in a chat session with the chatbot. Particularly, a user may type in text and the chatbot may respond back with an appropriate message in the form of text such that the chatbot may maintain the state of the conversation and respond to the user request in the current context. The dialogue in the chat session may be provided in a chat user interface 514.

The chat application 416 includes a natural language understanding (NLU) component 506, a dialogue management 508, and a message generator 510. The NLU component 506 is configured to process incoming messages from the user to extract the user's intent and entities in the incoming messages. For example, the user's intent may include “request conference,” “request update,” “request information,” “request invitation,” and/or so forth. The entities can include specific intent in the request. For example, the intent can be a date, time, location, and contact information of participants. In some aspects, the NLU component may include a supervised intent classification model that is trained on varieties of sentences as input and intents as a target. The NLU component may also include an entity extraction model (e.g., a pre-trained model such as conditional random fields [CRF]).

The dialogue management 508 is configured to keep track of the conversations between a user and the chatbot to determine an appropriate response. The dialogue management 508 may utilize a dictionary object that can be persisted with information about the current intent, current entities, persisted information that the user would have provided to the chatbot's previous questions, the chatbot's previous actions, results of API call, and/or so forth. In this way, the dialogue management 508 is context-aware and can look back into the conversational history to predict the next action. In some aspects, the dialogue management 508 may implement machine learning models (e.g., LSTM) to predict the next action. The next action can include responding to the user with an appropriate message, retrieving data from a database, making an API call and retrieving information matching the intent, and/or so forth.

If the next action is an API call or data retrieval, the dialogue management 508 makes a database request 512. In one example, the database request 512 can include requesting contact information associated with one or more participants from an address book. In another example, the database request 512 can include requesting calendar information associated with one or more user accounts associated with the user. In yet another example, the database request 512 can include requesting conference-related services (e.g., reserving a conference room).

The message generator 510 component includes one or more templates that map to action names. Based at least on the action predicted by the dialogue manager, the respective template message is invoked. If the template requires some placeholder values to be filled up, those values are also passed by the dialogue manager to the generator. Thereafter, the appropriate message is displayed to the user and the chatbot returns to a wait mode to listen for subsequent user input.

### Example Processes

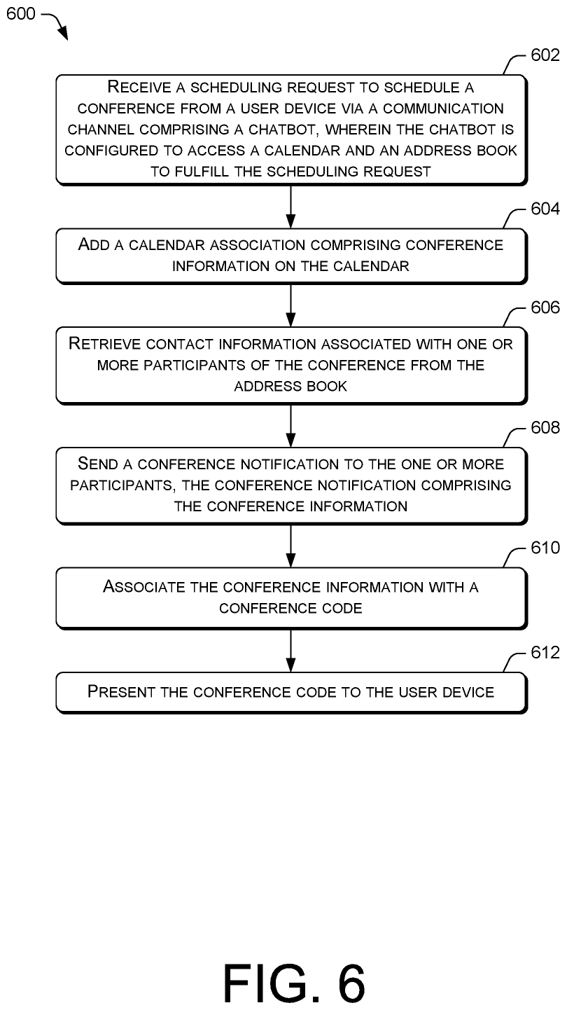

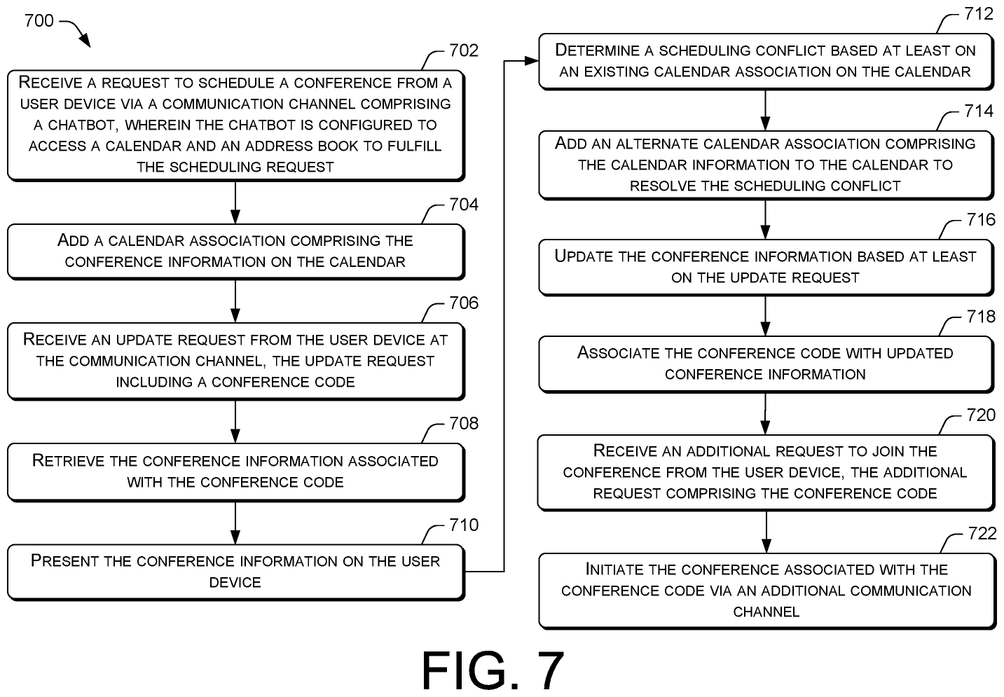

FIGS. 6 and 7 present illustrative processes 600-700 for organizing conferences. The processes 600-700 are illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

For discussion purposes, the processes 600-700 are described with reference to FIGS. 1-5. For example, processes 600 and 700 are exemplary processes performed by a conference management server, such as the conference management server of FIG. 1. In some aspects, processes 600 and 700 represent at least a portion of the scheduling function, notification function, and chatbot function implemented by scheduling module, notification module, and chatbot application of FIG. 4, respectively.

FIG. 6 is a flow diagram of an example process for starting, scheduling, and managing conferences. At block 602, the conference management server receives a request to perform conference operations from a user device that is operated by an organizer of a conference. In the illustrated embodiment, the conference management server receives a scheduling request to schedule a conference from a user device via a communication channel. In one example, the communication channel can include a chatbot. The chatbot is configured to access a calendar and an address book that are associated with a user of the user device to fulfill the scheduling request. At block 604, the server adds a calendar association comprising conference information on the calendar. The calendar association includes conference information associated with a calendar date and time. In various embodiments, the server may instruct a calendar module of a conference management application residing at the user device to add a calendar association on a calendar.

At block 606, the server retrieves contact information associated with one or more participants of the conference from the address book. The address book may be locally stored in the user device. At block 608, the server sends a conference notification to the one or more participants, the conference notification comprising the conference information. In some examples, the server sends the conference notification to a kiosk. At block 610, the server associates the conference information with a conference code, which may be generated via the kiosk using the code generator. The code may be a computer-readable code. At block 612, the server provides the conference code for display at the user device. In some aspects, the user device can scan the conference code at the kiosk. Subsequently, the server may receive additional requests to perform conference operations from the user device, wherein the additional requests comprise the conference code.

FIG. 7 is a flow diagram of an example process for updating conference information and initiating a conference. At block 702, the conference management server receives a scheduling request to schedule a conference from a user device operated by an organizer of a conference via a communication channel. The communication channel can include a chatbot. The chatbot is configured to access a calendar and an address book that are associated with a user of the user device to fulfill the scheduling request. In some aspects, the chatbot may make an API call to retrieve information from a calendar and an address book. At block 704, the server adds a calendar association comprising conference information on the calendar. In various embodiments, the server may instruct a calendar module of a conference management application residing at the user device to add a calendar association on a calendar. At block 706, the server receives an additional request to perform additional conference operations from the user device. For example, the server may receive an update request from the user device at the communication channel. The update request may include a conference code. Additionally, the update request may include proposed updated information, such as changes in conference date, time, location, participants, and/or so forth. The conference code may be entered or scanned using the user device. In the latter case, the user device may scan the conference code at the kiosk. At block 708, the server retrieves the existing conference information associated with the conference code, for example, from a distributed storage system or other databases.

At block 710, the server may send the existing conference information to the user device for the organizer's review. The conference information may include the date, time, and location of the conference before the update is made. The conference information may also include a list of participants or attendees, the subject of the conference, and/or so forth. At block 712, the server determines a scheduling conflict based at least on an existing calendar association on the calendar and the update request, which includes proposed updated information. The server can determine that there is a scheduling conflict for the organizer and/or one or more participants. For instance, the server can identify one or more individuals that have a scheduling conflict. If there is a scheduling conflict, the server may present one or more alternatives to the user device and receive a selection for an alternative. In one example, the server may present one or more alternatives based at least on one or more rules. For instance, the server may automatically present the next available time and date for the organizer as an alternative. In another example, the server may provide an alternative based at least on the location of the conference. The server may provide one or more alternatives simultaneously or provide the alternatives on a trial and error basis until the organizer selects an alternative. At block 714, the server adds an alternate calendar association comprising the calendar information to the calendar to resolve the scheduling conflict. At block 716, the server updates the conference information based at least on the update request. At block 718, the server associates the conference code with updated conference information. At block 720, the server may receive an additional request to join the conference from the user device operated by the organizer or at least one additional user device operated by a participant, the additional request comprising the conference code. At block 722, the server initiates the conference associated with the conference code via an additional communication channel.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. One or more non-transitory computer-readable media storing computer-executable instructions that upon execution cause one or more processors to perform acts comprising:
transmitting a scheduling request to schedule a conference from a user device via a communication channel comprising a chatbot, wherein the chatbot is configured to access a calendar and an address book associated with the user device to fulfill the scheduling request;
adding a calendar association comprising conference information to the calendar;
retrieving contact information associated with one or more participants of the conference from the address book;
sending a conference notification to the one or more participants, the conference notification comprising the conference information that is associated with a conference code;
scanning the conference code via the user device; and
initiating the conference via an additional communication channel.

2. The one or more non-transitory computer-readable media of claim 1, wherein the acts further comprise:
transmitting a request for the conference information from the user device;
retrieving the conference information associated with the conference code; and
presenting the conference information on the user device.

3. (canceled)

4. The one or more non-transitory computer-readable media of claim 1, wherein the acts further comprise:
transmitting an update request from the user device at the communication channel;
retrieving the conference information associated with the conference code;
updating the conference information based at least on the update request; and
associating the conference code with updated conference information.

5. The one or more non-transitory computer-readable media of claim 1, wherein the acts further comprise:
determining a scheduling conflict based at least on an existing calendar association on the calendar;
identifying one or more alternatives to resolve the scheduling conflict;
presenting the one or more alternatives to the user device via the communication channel;
receiving a selection for an alternative from the user device; and
adding an alternate calendar association comprising the conference information to the calendar.

6. The one or more non-transitory computer-readable media of claim 1, wherein the scheduling request includes at least one of a desired date, time, and location.

7. The one or more non-transitory computer-readable media of claim 1, wherein the calendar comprises a plurality of calendars, the individual calendars are associated with a user account associated with a user of the user device.

8. The one or more non-transitory computer-readable media of claim 1, wherein the acts further comprise:
attempting to obtain the contact information from the address book; and
in response to a failed attempt to obtain the contact information, sending a prompt via the chatbot to the user device to provide the contact information associated with the one or more participants.

9. A computer-implemented method, comprising:
transmitting a scheduling request to schedule a conference from a user device via a communication channel comprising a chatbot, wherein the chatbot is configured to access a calendar and an address book associated with the user device to fulfill the scheduling request;
adding a calendar association comprising conference information to the calendar;
retrieving contact information associated with one or more participants of the conference from the address book;
sending a conference notification to the one or more participants, the conference notification comprising the conference information that is associated with a conference code;
scanning the conference code via the user device; and
initiating the conference via an additional communication channel.

10. The computer-implemented method of claim 9, further comprising:
transmitting a request for the conference information from the user device;
retrieving the conference information associated with the conference code; and
presenting the conference information on the user device.

11. The computer-implemented method of claim 9, further comprising:
receiving a request to join the conference from an additional participant;
retrieving additional contact information associated with the additional participant;
sending the conference notification to the additional participant; and
adding the additional participant to the conference.

12. (canceled)

13. The computer-implemented method of claim 9, wherein the additional communication channel comprises one or more of text message, email, phone, or chatbot.

14. The computer-implemented method of claim 9, further comprising:
transmitting an update request from the user device at the communication channel;
retrieving the conference information associated with the conference code;
updating the conference information based at least on the update request; and
associating the conference code with updated conference information.

15. The computer-implemented method of claim 9, further comprising:
detecting a presence of the user device located within a predetermined location from a conference location; and
in response to detecting the presence of the user device, presenting a push notification on the user device to initiate the conference.

16. The computer-implemented method of claim 9, wherein the address book comprises a plurality of address books, the individual address books are associated with a user account associated with a user of the user device.

17. A system, comprising:
one or more non-transitory storage mediums configured to provide stored computer-readable instructions, the one or more non-transitory storage mediums coupled to one or more processors, the one or more processors configured to execute the computer-readable instructions to cause the one or more processors to:
transmit a scheduling request to schedule a conference from a user device via a communication channel comprising a chatbot, wherein the chatbot is configured to access a calendar and an address book associated with the user device to fulfill the scheduling request;
add a calendar association comprising conference information to the calendar;
retrieve contact information associated with one or more participants of the conference from the address book;
send a conference notification to the one or more participants, the conference notification comprising the conference information that is associated with a conference code;
scan the conference code via the user device; and
initiate the conference via an additional communication channel.

18. The system of claim 17, wherein the one or more processors are further configured to:
transmit a request for the conference information from the user device;
retrieve the conference information associated with the conference code; and
present the conference information on the user device.

19. (canceled)

20. The system of claim 17, wherein the one or more processors are further configured to:
transmit an update request from the user device at the communication channel, the update request including the conference code;
retrieve the conference information associated with the conference code;
update the conference information based at least on the update request; and
associate the conference code with updated conference information.

21. The one or more non-transitory computer-readable media of claim 1, wherein the acts further comprise:
detecting a presence of the user device located within a predetermined location from a conference location; and
in response to detecting the presence of the user device, presenting a push notification on the user device to initiate the conference.

22. The system of claim 17, wherein the one or more processors are further configured to:
detect a presence of the user device located within a predetermined location from a conference location; and
in response to detecting the presence of the user device, present a push notification on the user device to initiate the conference.

23. The system of claim 17, wherein the conference code comprises at least one of QR code, Aztec code, Maxicode, Data Matrix, and a barcode.
